(19) United States
(12) Patent Application Publication
(10) Pub. No.: US 2014/0089129 A1
(43) Pub. Date: Mar. 27, 2014

(54) TECHNIQUES FOR DETERMINING SUBSTITUTES FOR PRODUCTS INDICATED IN AN ELECTRONIC SHOPPING LIST

(71) Applicants: STUART ARGUE, Palo Alto, CA (US); ANTHONY EMILE MARCAR, San Francisco, CA (US)

(72) Inventors: STUART ARGUE, Palo Alto, CA (US); ANTHONY EMILE MARCAR, San Francisco, CA (US)

(73) Assignee: Wal-Mart Stores, Inc., Bentonville, AR (US)

(21) Appl. No.: 13/627,314

(22) Filed: Sep. 26, 2012

(51) Int. Cl. G06Q 30/06

(52) U.S. Cl. CPC G06Q 30/0631
USPC 705/26.7

(57) ABSTRACT

Systems and methods are disclosed for determining a set of substitutes to recommend to a user. In some embodiments, a method includes receiving an item from a remote computing device the item being indicative of a product sold by a retailer. The method also includes determining one or more potential substitutes for the product based on the item, wherein a plurality of attributes are associated with each potential substitute, including a substitute cost corresponding to the potential substitute and a substitution weight corresponding to the potential substitute. The method also includes for each of the one or more potential substitutes, determining a score of the potential substitute based on the plurality of attributes associated with the potential substitute. The method further includes determining a set of recommended substitutes based on the scores and providing the set of recommended substitutes to the remote computing device.

### BACKGROUND INFORMATION

1. Field of the Disclosure

The present invention relates generally to systems and methods for optimizing an electronic shopping list. In particular, examples of the present invention are related to techniques for determining substitutes to recommend for products indicated in an electronic shopping list based on attributes of the substitute.

2. Background

Many consumers collect coupons or search through sale announcements when preparing to shop for products such as groceries, office supplies, and household wares. Typically, coupons and/or sale announcements are distributed to shoppers electronically or through the mail. Consumers may spend significant time teeming through the coupons and sale announcements in an effort to find deals and ultimately reduce the amount of money spent on products. One drawback for the consumers, however, is that the amount of money that they spend on products may actually increase, as they purchase products that they otherwise would not have purchased due to the perceived savings associated with the coupons and/or sale announcements.

Another drawback with coupons and sale announcements is that consumers may be swayed from purchasing a preferred product to purchasing an alternate product due to the enticement of the coupon or sale. For example, a consumer who typically purchases PEPSI® or COKE® may be swayed into purchasing a private label cola due to a reduced price of the private label cola. It may be that the private label cola is low quality and not an acceptable substitute for PEPSI® or COKE®. Thus, any savings realized by the consumer may be mitigated by the fact that the consumer finds the substitute to be unacceptable.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIGS. 1A-1C are schematics illustrating a computing device displaying a graphical user interface in communication with a substitution server in accordance with some embodiments of the present disclosure;

FIG. 2 is a block diagram illustrating components of the computing device of FIGS. 1A-1C;

FIG. 3 is a block diagram illustrating components of the substitution server of FIGS. 1A-1C;

FIG. 4 is a flow chart illustrating an example method for generating a modified electronic shopping list in accordance with some embodiments of the present disclosure; and

FIG. 5 is a flow chart illustrating an example method for determining a set of substitutes for an item in accordance with some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In addition to or in lieu of collecting coupons and searching sale announcements, many consumers prepare shopping lists when preparing to shop for products. As used herein, the term “product” can refer to groceries, foods, office supplies, clothing wares, or any other fungible goods sold by a retailer. Some consumers utilize the capabilities of their computing devices to prepare their shopping lists. For example, a user of a computing device may prepare an electronic shopping list containing one or more items that each indicate a different product that the user intends to purchase. The shopping list can be stored by the computing device and later accessed while the user is shopping. As used herein, the term “computing device” can refer to mobile computing devices, such as mobile telephones, laptop computers, and tablet computers, or stationary computing devices. Users of mobile computing devices can store the shopping list on the mobile computing device and access the shopping list while shopping. Users of a stationary computing device can print a paper copy of the shopping list or can send the shopping list to a mobile computing device, either of which can be accessed while shopping.

In accordance with various embodiments of the present disclosure, techniques are described for generating electronic shopping lists. Furthermore, techniques are described for determining recommended substitutes for products appearing in the electronic shopping list. As used herein, the term “substitute” can refer to one or more substitute products that can be substituted for a product indicated by an item in the electronic shopping list. Additionally, techniques are disclosed for generating a modified electronic shopping list based on the selection of one or more recommended substitutes.

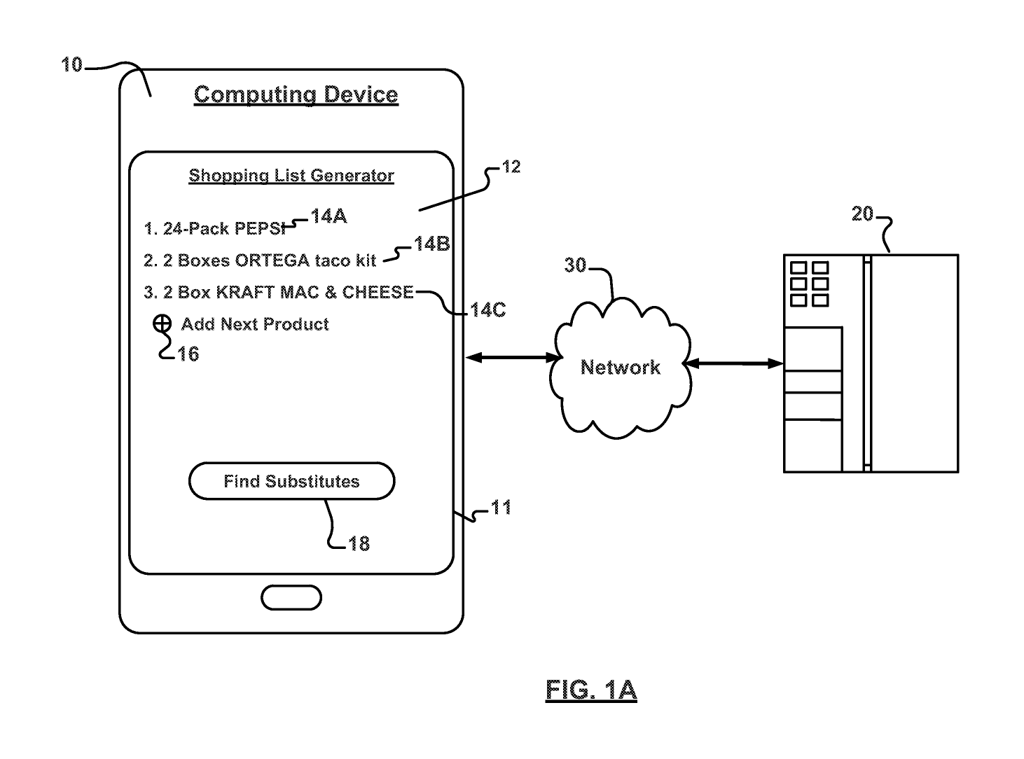

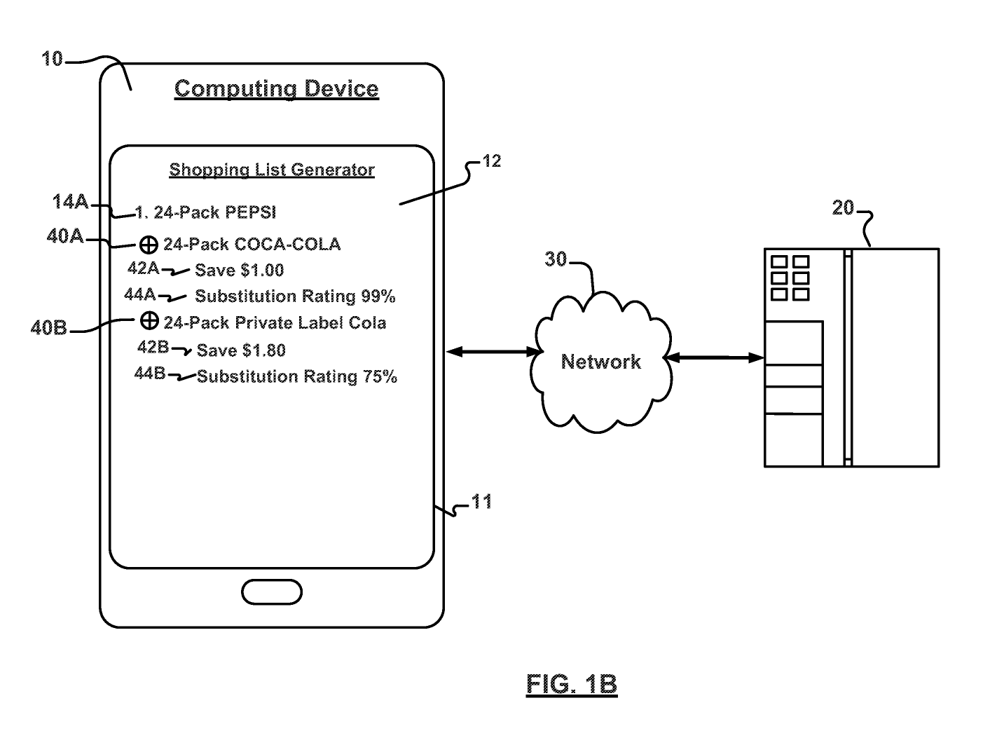

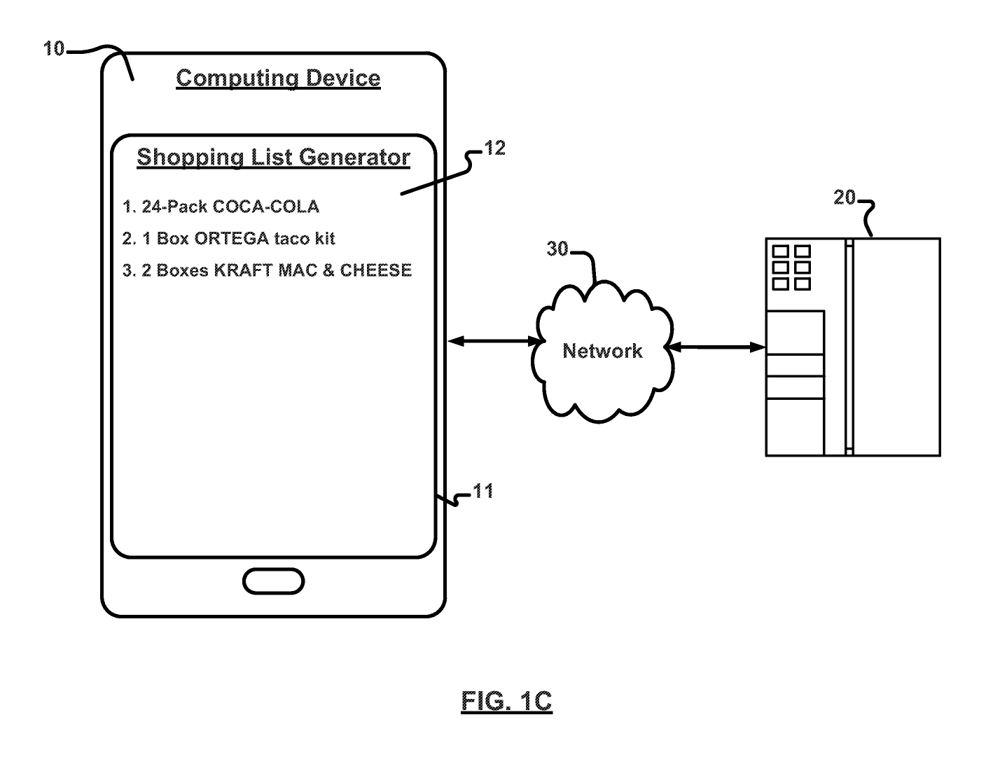

Referring now to FIG. 1A, a computing device 10 in communication with a substitution server 20 via a network 30 is illustrated. While one substitution server 20 is illustrated, the term “substitution server” refers to one or more servers that operate in an individual or distributed manner. Further, as used herein, the term “network” can refer to any communication network including, but not limited to, a wireless network, a cellular network, an intranet, the Internet, or combinations thereof. In the illustrated example, the computing device 10 is displaying a graphical user interface (GUI) 12 on a touch screen 11 of the computing device 10. While a touch screen 11 is illustrated, it should be appreciated that other user interfaces can be used to allow a user to interact with the computing device 10.

In one embodiment, the GUI 12 allows a user to generate an electronic shopping list and to request a set of recommended substitutes for the items listed in the electronic shopping list. The GUI 12 can display items selected by a user, e.g., item 14A, item 14B, and item 14C, a field 16 that allows the user to enter additional items, and a button 18 that indicates that the user is requesting a set of recommended substitutes.

An “item” can be indicative of a product sold by a retailer. The item can indicate a brand of the product and a unitary amount. In the example, the user has added a first item 14A indicating a 24 pack of PEPSI®, a second item 14B indicating an ORTEGA® taco kit, and a third item indicating a box of KRAFT MAC & CHEESE® to the electronic shopping list. The user can add other items to the electronic shopping list by pressing the region of the touch screen 11 where the field 16 is displayed. When the user presses on the field 16, the user is provided with an opportunity to add another item. In some embodiments, the user can be presented with one or more drop down menus from which the user can select another item. Alternatively, the user can be provided with a text field that allows the user to manually enter the name of a product. Once the user has provided the name of the product, a corresponding item can be displayed in the electronic shopping list.

When the user has finished generating the electronic shopping list, the user can press, or otherwise select, the button 18 to request recommended substitutes for the items in the electronic shopping lists. When the user selects the button 18, the computing device 10 can transmit the electronic shopping list and a request to determine a set of recommended substitutes for each of the items included in the electronic shopping list to the substitution server 20 via the network 30. In some embodiments, the button 18 is a “one-tap” button. A “one-tap” button is a button that when selected by a user, automatically sends the request and the entire electronic shopping list to the substitution server 20 without any additional confirmation from the user. In other embodiments, the computing device 20 may present additional menus to the user, such that the menus prompt the user to select which items to send to the substitution server 20.

The substitution server 20 can receive the electronic shopping list and the request and can determine a set of recommended substitutes for each item included in the electronic shopping list. In some embodiments, the substitution server 20 can provide recommended substitutes for a portion of the items. For example, the substitution server 20 may be unable to determine an acceptable substitute for an item, and therefore, may not provide recommended substitutes for the item. In other embodiments, the substitution server 20 may selectively choose which items to provide recommended substitutions for based on user settings or past user preferences. For example, if Kleenex® was an added item and in the past the user did not select any of the recommended substitutes for Kleenex®, the substitution server 20 may not recommended substitutes for Kleenex®. As will be described in greater detail below, the substitution server 20 may be configured to recommend a potential substitute for an item if the potential substitute is an adequate substitute for the item and the potential substitute provides the user an opportunity to save money. The substitution server 20 transmits a set of recommended substitutes for the item(s) included in the shopping list back to the computing device 10.

Upon receiving the sets of recommended substitutes from the substitution server 20, the computing device 10 can display each set of recommended substitutes in the GUI 12, thereby allowing the user to select one or more recommended substitutes for one or more of the items. FIG. 1B illustrates an example of the computing device 10 displaying a set of recommended substitutes for the PEPSI® item 14A. In the illustrated example, the computing device 10 is displaying a first recommended substitute 40A indicating a 24-pack of COCA-COLA® and a second recommended substitute 40B indicating a 24-pack of private label cola.

In some embodiments, the computing device 10 can further display attributes associated with each of the recommended substitutes. As used herein the term “attribute” can refer to any property that has been associated with the substitute product indicated by recommended substitute. Examples of attributes can include, but are not limited to, a substitute cost of the substitute product, a cost difference between the substitute product and the product indicated by the item, a substitution weight indicating a degree of acceptability of the substitute product for the product, and a quality rating of the substitute product. In the illustrated example, the computing device 10 is displaying a cost difference attribute, e.g., cost difference attributes 42A and 42B, and a substitution weight attribute, e.g., substitute weight attributes 44A and 44B, in relation to each of the recommended substitutes. It should be appreciated that the computing device 10 can display other attributes in the GUI 12 or may not display any attributes in the GUI.

For each item, the user can select one of the displayed recommended substitutes for inclusion in the electronic shopping list or can opt to keep the original item in the electronic shopping list. Once the user has made a selection of a recommended substitute, the recommended substitute can replace the item in the electronic shopping list, thereby creating a modified electronic shopping list. FIG. 1C illustrates an example of the computing device 10 displaying a modified electronic shopping list in the GUI 12. As can be appreciated, the user has opted to replace the 24-pack of PEPSI® with a 24-pack of COCA-COLA® but has opted to keep the original selections of ORTEGA® taco kit and KRAFT MAC & CHEESE®.

Once the user has finished creating the modified electronic shopping list, the computing device 10 can store the modified electronic shopping list in memory. In some embodiments, the computing device 10 can also communicate the modified electronic shopping list 50 to the substitution server 20. The substitution server 20 can utilize the modified electronic shopping list 50 to track the user's substitutions and/or to provide a follow-up survey requesting a rating of the acceptability of the substitution for the product indicated by the originally provided item.

The examples of FIGS. 1A-1C are provided for example only and not intended to be limiting. It should be appreciated that variations of the GUI 12 are contemplated and are within the scope of the disclosure. Furthermore, while a mobile computing device is depicted, the computing device 10 can be a stationary computing device as well.

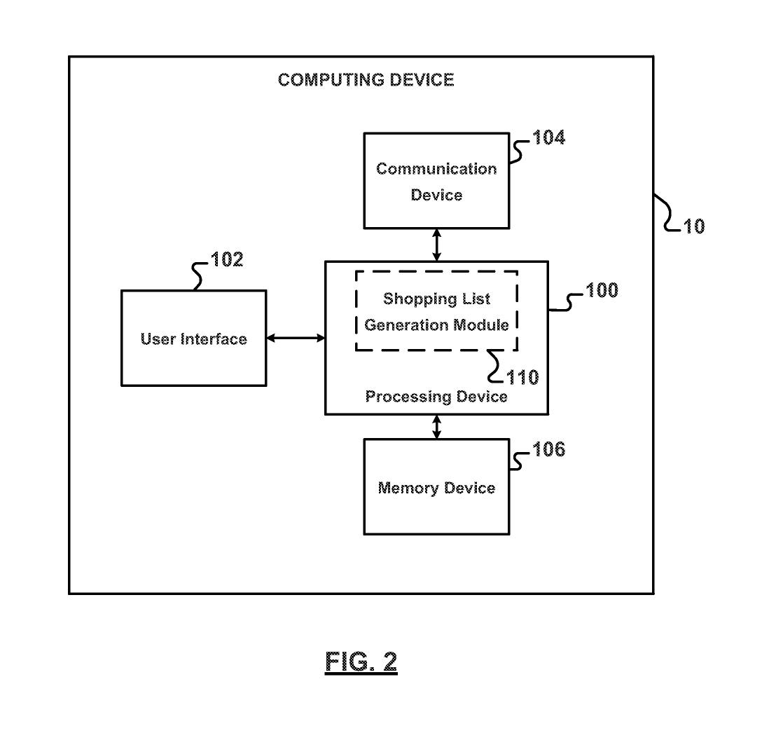

Referring now to FIG. 2, a block diagram illustrating example components of the computing device 10 of FIGS. 1A-1C is depicted. In the example embodiment, the computing device 10 includes a processing device 100, a user interface 102, a communication device 104, and a memory device 106.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the computing device. In the illustrative embodiment, the processing device 100 also executes a shopping list generation module 110, which is described in greater detail below.

The user interface 102 is a device that allows a user to interact with the computing device 10. While one user interface 102 is shown, the term “user interface” can include, but is not limited to, a touch screen, a physical keyboard, a mouse, a microphone, and/or a speaker. The communication device 104 is a device that allows the computing device 10 to communicate with another device, e.g., the substitution server 20, via the network 30. The communication device 104 can include one or more wireless transceivers for performing wireless communication and/or one or more communication ports for performing wired communication. The memory device 106 is a device that stores data generated or received by the computing device 10. The memory device 106 can include, but is not limited to a hard disc drive, an optical disc drive, and/or a flash memory drive.

In some embodiments, the shopping list generation module 110 is embodied as processor-executable instructions stored in the memory of the processing device 100. The processing device 100 can execute the shopping list generation module 110. The shopping list generation module 110 can be preloaded into the operating system of the computing device 10, can be downloaded from a third party server 10 by a user of the computing device 10, or be generated on the computing device 10.

The shopping list generation module 110 provides the GUI 12 and receives items via user input, which collectively define the electronic shopping list. The shopping list generation module 110 further receives commands to request recommended substitutes from the substitution server 20. In response to receiving sets of recommended substitutes from the substitution server 20, the shopping list generation module 110 displays the sets of recommended substitutes corresponding to their respective items in the GUI 12 and receives user input indicating a selection of one or more of the recommended substitutes. The shopping list generation module 110 replaces the selected recommended substitutes for the corresponding items, thereby creating the modified electronic shopping list. The shopping list generation module 110 can store the modified electronic shopping list in the memory device 106, which can be accessed by the user at a later time. It should be appreciated that the shopping list generation module 110 may be configured to perform additional functions without departing from the scope of this disclosure.

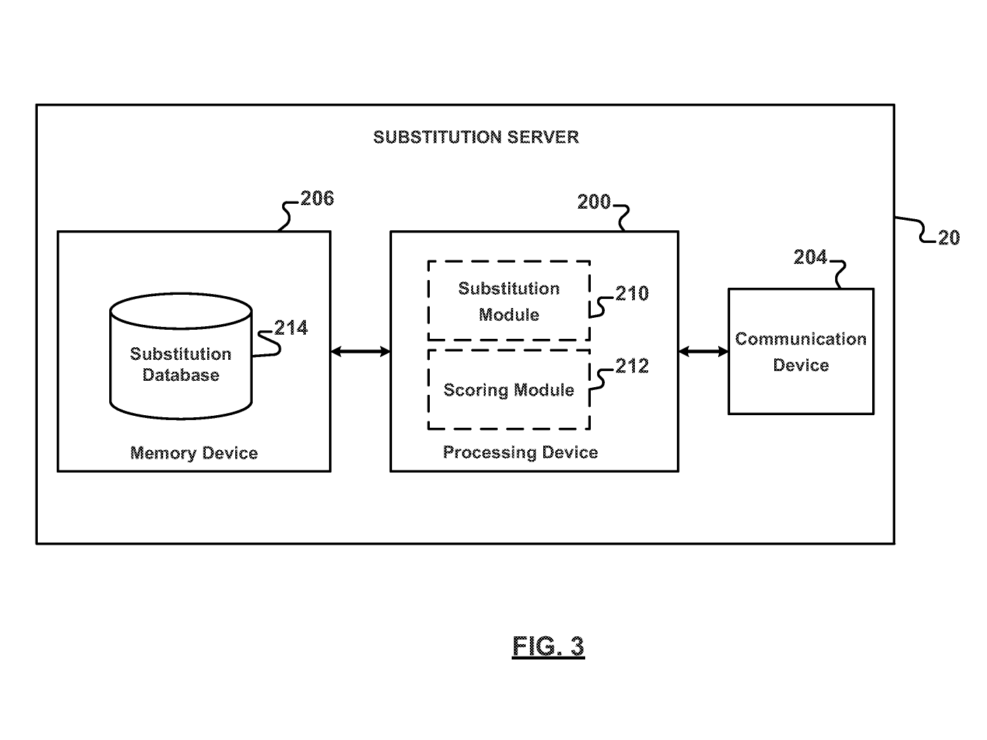

Referring now to FIG. 3, a block diagram illustrating an exemplary substitution server 20 is depicted. In an exemplary embodiment, the substitution server 20 includes a processing device 200, a communication device 204, and memory device 206.

The processing device 200 can include memory, e.g., read only memory (ROM) and random access memory (RAM), storing processor-executable instructions and one or more processors that execute the processor-executable instructions. In embodiments where the processing device 200 includes two or more processors, the processors can operate in a parallel or distributed manner. In the illustrative embodiment, the processing device 200 executes a substitution module 210 and a scoring module 220, which are described in greater detail below.

The communication device 204 is a device that allows the substitution server 20 to communicate with another device, e.g., the computing device 10, via the network 30. The communication device 204 can include one or more wireless transceivers for performing wireless communication and/or one or more communication ports for performing wired communication.

The memory device 206 is a device that stores data generated or received by the substitution server 20. The memory device 206 can include, but is not limited to a hard disc drive, an optical disc drive, and/or a flash memory drive. The memory device 206 is accessible to the processing device 200. A substitution database 214, or a similar structure, can be stored in the memory device 206. In an exemplary embodiment, a retailer maintains the substitution server 20, such that the items and the substitutions corresponding thereto are all indicative of products offered by the retailer. Alternatively, the substitution server 20 can be maintained by a third party or a party affiliated with the retailer.

The substitution database 214 stores potential substitutes for a plurality of different items. In some embodiments, an item is related to one or more potential substitutes for the item. A potential substitute indicates one or more substitute products that could serve as a substitute for the product indicated by item. In most cases, a substitute product is a single product that can replace the product indicated by the item. For example, a first brand of raisin bran cereal may be a potential substitute for a second brand of raisin bran. As should be appreciated, however, some products are sold as a combination of other products. For example, a taco kit may include tortillas, taco seasoning, and salsa. Thus, a potential substitute for a particular taco kit could include individual packages of tortillas, taco seasoning, and salsa. The combination of the individual products would constitute the substitute product for the taco kit. The potential substitutes can be determined for each item stored in the substitution database 214 in any suitable manner. For instance, the retailer that sells the products or consumers may determine the substitute products for the products sold by the retailer. Alternatively or additionally, the potential substitutes can be learned using machine-learning techniques. In these embodiments, the potential substitutes can be learned from the purchase histories of one or more consumers and/or from previous substitutions made by one or more consumers.

The substitution database 214 also stores attributes for each of the potential substitutes. As discussed, an attribute can be any property of the substitute product indicated by the potential substitute. A non-exhaustive list of attributes includes a substitute cost of the substitute product, a substitution weight of the substitute product, a cost difference between the substitute product and the product indicated by the item to which the potential substitute is related, a quality rating, a cost per unit, e.g., price per pound or fluid ounce, or a cost difference per unit.

The substitution weight can be a qualitative measure indicative of a degree of acceptability of a substitute product for a product. In some embodiments, the substitution weight is a value between 0 and 1. The acceptability of a substitute product for a product is unrelated to the cost of the product, but rather whether the substitute product is likely to be accepted by a consumer when substituted for a particular product. A relatively low substitution weight can indicate that the substitute product is unlikely to be an acceptable substitute for the particular product. Similarly, a relatively high substitution weight can indicate that the substitute product is likely to be an acceptable substitute for the particular product. For example, COCA-COLA® may have a high substitution weight when related to PEPSI®, but may have a very low substitution weight when related to SPRITE®.

The attributes can be collected in any suitable manner. For example, the cost-related attributes can be provided by the retailer or calculated from other cost-related attributes. The qualitative measures such as substitution weight and quality rating can be collected from one or more consumers. For example, the substitution weight and/or the quality rating can be determined from consumer feedback, surveys, and/or consumer testing. Furthermore, some of the attributes can be learned using machine-learning techniques. In these embodiments, the substitution weight can be made by monitoring the recommended substitutes that are presented to one or more users and which recommended substitutes are adopted by the one or more users.

The substitution module 210 receives an electronic shopping list from a computing device 10 and determines sets of recommended substitutes based on the items contained in the electronic shopping list. As described, the electronic shopping list contains one or more items. For each item, the substitution module 210 determines a set of recommended substitutes. In some embodiments, a set of recommended substitutes for an item can be an empty set if the substitution module 210 is unable to identify any adequate substitutes for the item.

In some embodiments, the substitution module 210 queries the substitution database 214 with an item. The substitution database 214 returns the potential substitutes that relate to the item and the attributes associated with each potential substitute. The scoring module 212 can determine a score for each of the potential substitutes based on the attributes of the potential substitution. After the scoring module 212 has determined the score of a potential substitute, the substitution module 210 determines whether to recommend the potential substitute to the user, i.e., whether to include the potential substitute in the set of recommended substitutes, based on the score of the potential substitute. When the substitution module 210 has determined the sets of recommended substitutes for all of the items in the electronic shopping list, the substitution module 210 can communicate the sets of recommended substitutes to the computing device 10 via the communication device 204.

It is appreciated that the foregoing example of the substitution server 20 is not intended to be limiting. Variations of the exemplary substitution server 20 are contemplated and within the scope of the disclosure. For example, the memory device 206 may store a look-up table or a hash table that relates items to potential substitutes.

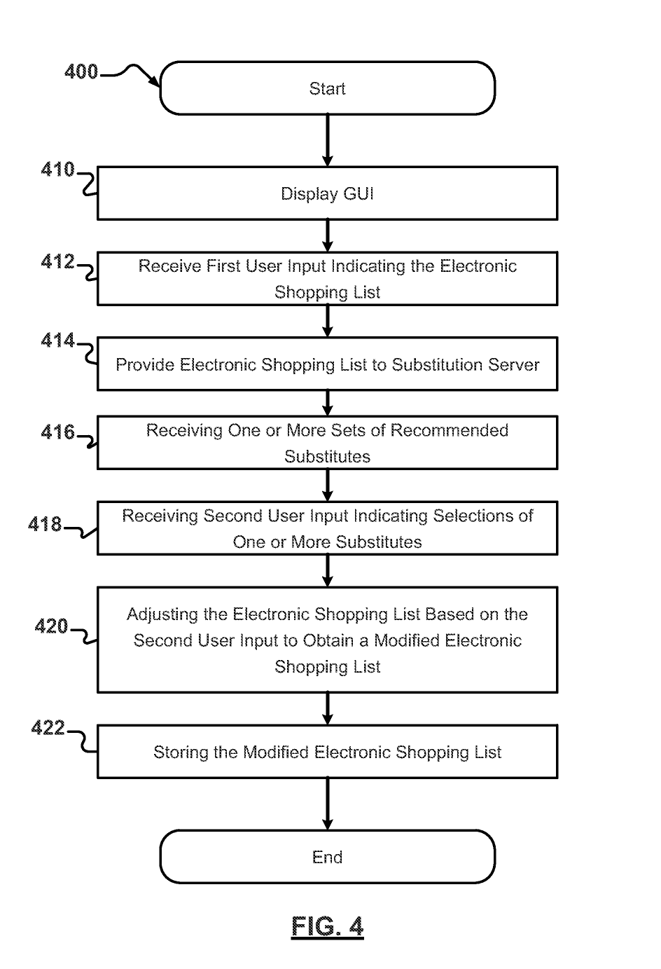

Referring now to FIG. 4, an example method 400 for determining a modified electronic shopping list is illustrated. In some embodiments, the shopping list generation module 110 (FIG. 2) executes the method 400. At operation 410, the shopping list generation module 110 displays the GUI 12. As discussed above, the GUI 12 allows the user to enter an electronic shopping list that includes one or more items. At operation 412, the GUI 12 receives first user input indicating one or more item selections, thereby creating an electronic shopping list.

At operation 414, the shopping list generation module 110 provides the electronic shopping list to the substitution server 20. The shopping list generation module 110 may provide the electronic shopping list to the substitution server 20 at the command of the user. For example, the user may provide user input by pressing, or otherwise selecting, a “one-tap” button displayed in the GUI 12. In response to the user input, the shopping list generation module 110 communicates the electronic shopping list to the substitution server 20 over the network 30.

At operation 416, the shopping list generation module 110 receives one or more sets of recommended substitutes. Each set of recommended substitutes corresponds to one of the items. Thus, if N items were provided to the substitution server 20, the shopping list generation module 110 may receive up to N sets of recommended substitutes. As indicated previously, one or more of the N sets can be empty sets. The sets of recommended substitutes can be displayed in relation to the items to which they correspond.

At operation 418, the shopping list generation module 110 receives second user input indicating a selection of one or more of the recommended substitutes. At operation 420, the shopping list generation module 110 substitutes the selected substitutions for any items to which the selected substitutions correspond. The result of the foregoing operation is a modified electronic shopping list. At operation 422, the shopping list generation module 110 stores the modified electronic shopping list in the memory device 106 of the computing device 10. In some embodiments, the shopping list generation module 110 can communicate the modified electronic shopping list to the substitution server 20.

The method 400 of FIG. 4 is provided for example and not intended to be limiting. It should be appreciated that the method 400 may include additional operations and some operations may be varied without departing from the scope of the disclosure.

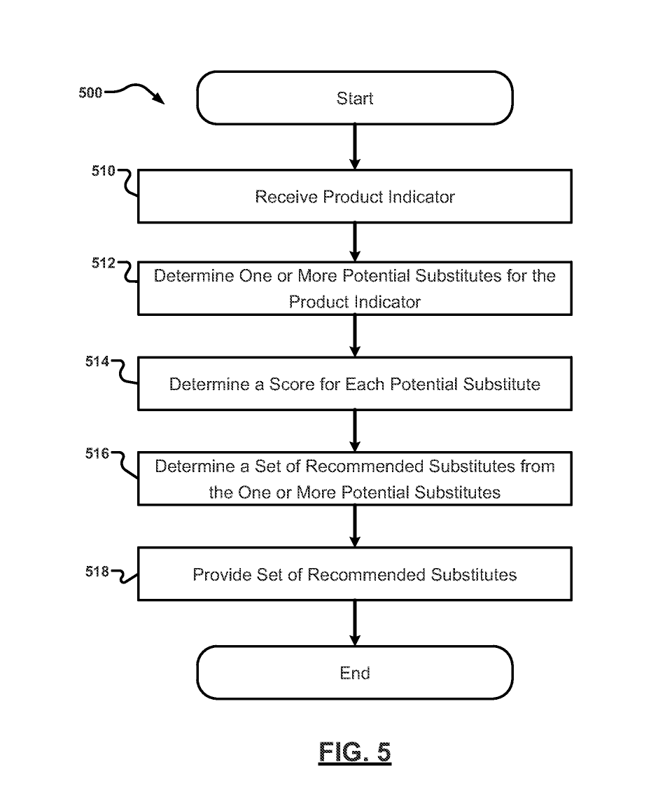

Referring now to FIG. 5, an exemplary method 500 for determining a set of recommended substitutes for an item is illustrated. In some embodiments, the method 500 is executed by the processing device 200 of the substitution server 20. As was discussed above, the substitution server 200 receives an electronic shopping list containing one or more items. The method 500 of FIG. 5 explains the process of determining a set of recommended substitutes for one item. It should be appreciated, however, that the techniques disclosed herein can be applied to determine sets of recommended substitutes for each of the items in the electronic shopping list.

At operation 510, the substitution module 210 receives an item. The item can be indicative of a product sold by a retailer. In some embodiments, the item may indicate a brand of the product and a unitary amount of the product. For example, the substitution module 210 may receive an item indicating a 24-pack of PEPSI®.

At operation 512, the substitution module 210 determines one or more potential substitutes for the item. In some embodiments, the substitution module 210 queries the substitution database 214 to determine the one or more potential substitutes. The substitution database 214 returns the potential substitutes that have been related to the item in the substitutions database 214. Following the example provided above, in response to an item indicating a 24-pack of PEPSI®, the substitution module 210 may determine the potential substitutes related to the 24-pack of PEPSI are a 24-pack of COCA-COLA, a 24-pack of a private label cola, a 24-pack of private label root-beer, and a 6-pack of PEPSI. Furthermore, the substitution database 214 may return the attributes associated with each of the potential substitutes.

At operation 514, the scoring module 212 determines a score for each potential substitute based on the attributes of the potential substitute. In some embodiments, the scoring module 212 can determine the score of a potential substitute based on the substitution weight of the potential substitute and a cost difference between the substitute cost of the substitute product and the product cost of the product. For example, the score of a potential substitute may be determined according to:

S_{P}=ΔC*w

where S_{P} is the score of a potential substitute, P, ΔC is cost difference between the substitute cost and the product cost, and w is the substitution weight of the potential substitute. It should be appreciated that the score can be calculated in any other suitable manner. Additionally, the manner in which the score is calculated can be designed to put a greater emphasis on either cost difference or substitution weight. Furthermore, the score can be based on additional attributes such as the quality rating of the substitute.

At operation 516, the substitution module 210 determines a set of recommended substitutes from the one or more potential substitutes based on the scores thereof. In some embodiments, the substitution module 210 compares the score of a potential substitute to a score threshold. If the score exceeds the score threshold, the potential substitute is included in the set of recommended substitutes. If none of the scores exceed the score threshold, the set of recommended substitutes may be empty. The score threshold can be determined in any suitable manner. For example, the score threshold can be set by the retailer or the user that provided the electronic shopping list. Alternatively, the score threshold may be learned by monitoring feedback from consumers regarding previous substitution recommendations using a neural network, or any other suitable learning technique. It should be appreciated that the set of recommended substitutes can be determined in other manners as well. For example, the substitution module 510 can include the M, e.g., M=3, highest scored potential substitutes in the set of recommended substitutes.

At operation 518, the set of recommended substitutes is provided to the computing device 10. It should be appreciated that the set of recommended substitutes may be combined with other sets of recommended substitutes, which are collectively transmitted to the computing device 10.

The method 500 of FIG. 5 is provided for example and not intended to be limiting. It should be appreciated that the method 500 may include additional operations and some operations may be varied without departing from the scope of the disclosure.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
receiving, at a processing device of a substitution server, an item from a remote computing device, the item being indicative of a product sold by a retailer;
determining, at the processing device, one or more potential substitutes for the item based on the item, each potential substitute indicating a substitute product corresponding to the product, wherein a plurality of attributes are associated with each potential substitute, the plurality of attributes including a substitute cost of the substitute product and a substitution weight corresponding to the potential substitute, the substitution weight being indicative of a degree of acceptability of the substitute product for the product;
for each of the one or more potential substitutes, determining, at the processing device, a score of the potential substitute based on the plurality of attributes associated with the potential substitute;
determining, at the processing device, a set of recommended substitutes from the one or more potential substitutes based on the scores of the one or more potential substitutes; and
providing, from the processing device, the set of recommended substitutes to the remote computing device.

2. The method of claim 1, wherein each of the one or more potential substitutes includes one or more alternate items, the one or more alternate items collectively defining the potential substitute.

3. The method of claim 1, further comprising receiving an electronic shopping list containing a plurality of different items, the plurality of different items including the item.

4. The method of claim 1, wherein the score of each potential substitute is based on a difference between the substitute cost of the substitute product and a product cost of the product.

5. The method of claim 4, wherein the score of each potential substitute is further based on the substitution weight associated with the potential substitute.

6. The method of claim 5, wherein the score of each potential substitute is based on a product of the difference and the substitution weight associated with the potential substitute.

7. The method of claim 1, wherein determining the set of recommended substitutes includes, for each of the one or more potential substitutes:
comparing the score of the potential substitute with a score threshold; and
including the potential substitute in the set of recommended substitutes when the score exceeds the score threshold.

8. The method of claim 1, wherein obtaining the one or more potential substitutes includes querying a substitution database using the item, the substitution database relating the one or more potential substitutes to the item.

9. The method of claim 8, wherein the substitution database stores entries for a plurality of different items, each of the different items having a set of potential substitutes related thereto, wherein the plurality of attributes are associated with each of the potential substitutes.

10. A substitution server having a processing device, the substitution server comprising:
a substitution module configured to:
a) receive an item from a remote computing device, the item being indicative of a product sold by a retailer, and
b) determine one or more potential substitutes for the product based on the item, each potential substitute indicating a substitute product corresponding to the product, wherein a plurality of attributes are associated with each potential substitute, the plurality of attributes including a substitute cost of the substitute product and a substitution weight corresponding to the potential substitute, the substitution weight being indicative of a degree of acceptability of the substitute product for the product; and
a scoring module configured to determine, for each of the one or more potential substitutes, a score of the potential substitute based on the plurality of attributes associated with the potential substitute,
wherein the substitution module is further configured to determine a set of recommended substitutes from the one or more potential substitutes based on the scores of the one or more potential substitutes and to provide the set of recommended substitutes to the remote computing device.

11. The server of claim 10, wherein each of the one or more potential substitutes includes one or more substitute items, the one or more alternate items collectively defining the potential substitute.

12. The server of claim 10, wherein the substitution module is configured to receive an electronic shopping list containing a plurality of different items, the plurality of different items including the item.

13. The server of claim 10, wherein the score of each potential substitute is based on a difference between the substitute cost of the substitute product and a product cost of the product.

14. The server of claim 13, wherein the score of each potential substitute is further based on the substitution weight associated with the potential substitute.

15. The server of claim 14, wherein the score of each potential substitute is based on a product of the difference and the rating associated with the potential substitute.

16. The server of claim 10, wherein the substitution module determines whether to include a potential substitute in the set of recommended substitutes by:
comparing the score of the potential substitute with a score threshold; and
including the potential substitute in the set of recommended substitutes when the score exceeds the score threshold.

17. The server of claim 10, further comprising a substitution database that relates the item with the one or more potential substitutes, wherein the substitution module obtains the one or more potential substitutes by querying the substitution database using the item.

18. The server of claim 17, wherein the substitution database stores entries for a plurality of different items, each of the different items having a set of potential substitutes related thereto, wherein the plurality of attributes are associated with each of the potential substitutes.

19. A computer-implemented method executed by a processing device of a computing device, comprising:
displaying, at the computing device, a graphical user interface that allows a user to enter an electronic shopping list including one or more items, each item being indicative of a product;
receiving, at the computing device, first user input indicating the electronic shopping list;
providing, from the computing device, the electronic shopping list to a remote server;
receiving, at the computing device, one or more sets of recommended substitutes, each set of recommended substitutes indicating one or more substitutes for one of the items;
displaying, at the computing device, the sets of recommended substitutes in the graphical user interface;
receiving, at the computing device, second user input indicating selections of one or more substitutes displayed in the graphical user interface;
adjusting, at the computing device, the electronic shopping list based on the second user input to obtain a modified electronic shopping list; and
storing, at the computing device, the modified electronic shopping list.

20. The method of claim 19, wherein the graphical user displays a one-touch button, wherein when the one-touch button is selected by the user, the electronic shopping list is automatically provided to the remote server without any additional user input.
